(19) United States
(12) Patent Application Publication
(10) Pub. No.: US 2021/0203273 A1
(43) Pub. Date: Jul. 1, 2021

(54) HIGH-PERFORMANCE LOW-COST SOLAR PHOTOVOLTAIC SYSTEMS FOR COMMERCIAL AND INDUSTRIAL ROOFTOP APPLICATIONS

(71) Applicant: David CHING, Tracy, CA (US)

(72) Inventors: Gianluigi Mascolo, Monte Sereno, CA (US); Karl-Josef Kramer, Livermore, CA (US)

(73) Assignee: David Ching, Tracy, CA (US)

(21) Appl. No.: 17/059,409

(22) PCT Filed: Jun. 14, 2019
(86) PCT No.: PCT/US19/37290

§ 371 Date: Nov. 27, 2020

Related U.S. Application Data
(60) Provisional application No. 62/685,437, filed on Jun. 15, 2018.

(51) Int. Cl. H02S 30/10; H02S 20/23; H02S 40/34

(52) U.S. Cl. CPC H02S 30/10; F16M 11/38; H02S 40/34; H02S 20/23

(57) ABSTRACT

Embodiments for PV modules with integrated mounting systems are presented. Application of the systems are found primarily but not solely in commercial and industrial rooftop solar installations. The disclosed self-aligning components are easily installed both in North-South and in East-West geometry scenarios, resulting in greatly reduced complexity and installation time. The use of polymeric or fiber reinforced polymeric frames and mounting structures eliminates the need for grounding. Features are presented which remove the need to have any tooling or hardware along with the installation. In addition, the presented structures support the PV laminates strategically and enable the use of thinner glass, thereby reducing overall system weight. Installing the systems adhesively, such as on membrane roofs, eliminates the need for ballast pavers and further reduces overall system weight, making it attractive for rooftop installations that would otherwise not be strong enough to support a ballasted PV module installation.

### CROSS-REFERENCE TO RELATED APPLICATIONS

This application claims priority to U.S. Provisional Application Ser. No. 62/685,437, filed Jun. 15, 2018, which is hereby incorporated by reference in its entirety.

### FIELD OF THE INVENTION

The present technology relates to photovoltaic modules and mounting systems.

### BACKGROUND

As photovoltaic (PV) modules and inverters have experienced significant drops in cost, the focus for further cost reduction of overall PV installations and projects has now focused to reducing cost of the remaining components, the Balance of System (BOS). It is therefore mandatory that installing PV modules needs to become cheaper overall, with savings harvested especially on hardware cost, ease, speed and efficiency of installation. All this is needed for continued long term solid growth in the PV solar market.

Using lighter weight modules and racking systems increases the overall available market, especially for commercial and industrial rooftops, especially to those roofs that are not strong enough to support heavy ballasted PV systems. They also enable installation by a single person rather than by two people and, when designed properly, can improve the ergonomics and well-being of the installers.

Systems not requiring roof penetration for installation are desirable to readily retain roof warranties.

Lighter panels and installation systems need to be designed to pass certification and have the necessary strength and resistance against wind, snow load and fire.

### BRIEF SUMMARY OF THE INVENTION

The presented invention introduces various embodiments of PV modules and mounting systems that are mainly based on injection molded plastic or injection molded fiber reinforced plastic frame designs or combinations of injection molded designs with metal components. Such designs enable, at comparatively low cost, introduction of valuable features for easy, fast and low-cost installation. Most presented features hold for so-called north-south as well as east-west design installations and are considered to apply to any type of installations. Features specifically beneficial to either north-south or east-west designs will become apparent to readers with an ordinary skill in the art or will be pointed out separately. Several embodiments are presented with features enabling bringing modules onto rooftops as an all-in-one package. In addition, the disclosed concepts enable fast installation that can be carried out by a single person and without the use of tools. Quick, yet secure roof installation, attachment and interlocking of modules and arrays of modules is achieved.

Even though the presented invention focuses on demonstrating modules that are attached adhesively to rooftops, such as membrane-based rooftops of TPM, EPDM or other roof membranes, the extension of technology also enables use for ballasted installations or installation via penetration of rooftops and fixation by fasteners.

This disclosure primarily envisions firstly the use of an unframed photovoltaic solar module laminates, such as but not limited to a 60 or 72 cell photovoltaic module, made of for instance 60 or 72 multi- or monocrystalline silicon solar cells of 156 mm or so on a side. The same features apply to the use of other solar cell and cell counts and arrangements, as well as other module materials such as gallium arsenide or thin film module, for instance but not limited to thin film modules comprised of copper indium gallium selenide (CIGS) or Cadmium telluride (CdTe) or perovskite technology or combinations thereof. With suitable adaptations, the presented features can be applied to framed photovoltaic modules as well. Their use and application are envisioned and enclosed in full in this disclosure.

In this invention, said solar module laminate is enclosed by an essentially rectangular molded frame, preferably with rounded or chamfered edges, and glued or mechanically attached to the frame in such a way as to leave a gap around the perimeter of the laminate that enables easy water drainage from the laminate surface and thus reduces build-up of dirt along the edges of the module. The rectangular-shaped frame also serves to provide the kind of protection and structural strength that a standard aluminum frame provides.

The mounting structure that serves to secure the module to the roof is attached during the manufacturing process of the frame to the module, preferably, but not limited to, the underside of the panel. The attachment is preferably done in such a way that the overall form factor of the panel is not or only slightly increased, especially in the two long directions of the panel. This is in turn achieved by designing the mounting components to be collapsible and nested within the form factor of the module frame for shipping and transportation to the installation side. Those features are also designed in such a way that the stacking height is kept at a minimum. Only at the time of installation, said collapsed mounting structure or structures are unfolded and put in place. By assuring such attachment of the mounting structure to the panel it is assured that the panel, with its mounting structure attached, can be carried to its designated installation location on the roof, without the need of carrying any peripheral mounting structure components or tools, and can be carried to its location by a single person and also be installed by a single person that doesn't necessarily have skills to install solar systems due to the simplicity of this invention. Certain embodiments enclosed within benefit from having some additional parts at the installation site, such as specific valley mounting feet in one embodiment. It is, however, always conceived to have such separate parts designable in such a way that they can be snapped to the module support frame structure for shipping and transportation.

Keeping the outside dimensions of the module with frame and the racking components essentially the same as the module with frame assures that the shipping density can be significantly higher than for such modules that have separated racking components. Practically, the mounting components are incorporated in the silhouette and maximum dimensions of the frame of the laminate. Shipping cost can thus be significantly reduced.

Also, no packaging or wrapping material and spacers are needed and therefore there is very little material cleanup and removal effort required on the roof after the installation. This offers significant savings to installers and developers of solar projects.

We present various concepts, including a structure allowing integrated module with installation system that can be stacked at essentially the same form factor and density as modules, either by nesting deflector and feet within the frame for shipment or by nesting feet underneath deflector and within the thickness confines of the frame. We present embodiments where mounting feet are rotated out for installation, as well as embodiments where mounting feet are snapped to the frame for transport and then unsnapped and arranged at the installation site. Some embodiments are presented that show in detail the local priming of the region where said feet attach to the roof surfaces such as roof membranes. The presented concepts, for the case of adhesive mounting, allow to reduce the surface priming need prior to installation to specifically those locations on the roof that the mounting feet are attached to.

In addition, we teach the use of various connections to ensure solid connectivity between modules. When looking at the array of installed PV modules with mounting systems, the presented embodiments have in common typically that in one direction, the modules are connected via shared feet or via feet and in the other direction via linkages between their frames or their frame supports or both. These presented mechanical interconnections uniquely combine a rigid and sound interconnection with the flexibility to accommodate uneven roof surfaces. With this sound interlinking in both directions, we increase the tributary area and hold-down strength component that one module gets from its neighbors in the event of experiencing uplift forces from wind loads. This in turn qualifies the system to withstand higher wind loads. The mounting structure is shipped as integral with one module, called primary module for now, but allow for fixation of adjacent modules.

The presented configurations cause the entire module array to be positively interlocked mechanically for maximum structural efficiency in withstanding environmental loads.

In the various embodiments, we present mounting structures that are attached to the module with frame prior to installation, but with differences in the design and function of the mounting structure. These embodiments are based on a concept capable to work both with a molded frame as well as with a standard Al frame module, but from a cost point-of-view, molded frames are more readily capable of providing the disclosed features at lower cost. The embodiments include at least one structure that is tucked in, preferentially below the module and, upon installation can swing or slide out or be removed and reattached to lift up at least one side of the module, for instance the North side (on an installation in the Northern Hemisphere). Optionally, an additional similar structure can be attached to the South side (also for the example of installation in the Northern Hemisphere), preferably to lift up said module to a lower extent. Such additional lifting can be advised when a ballasted design is chosen which requires pavers or other weight carriers to be placed in such a way as to not cause additional shading issues to a module's Northern neighbor or neighbors.

Various embodiments for accomplishing said additional lifting of the second (typically southern) side, in a north-south oriented structure, are shown.

Said embodiments enable East-West connection between adjacent modules by an integrated panel that swings or slides out to enable connection to the neighbor module.

The use of plastic or polymeric or fiber reinforced plastic or polymeric frames and mounting structures eliminates the need of grounding, since the plastic or polymeric frames are electrically isolating. This reduces the liability of an installer to assure an appropriate, long term reliable grounding connection, as well as removing the need for grounding hardware such as lugs and cables, as well as removing the need for competent and qualified grounding installation.

### BRIEF DESCRIPTION OF THE DRAWINGS

The features, nature, and advantages of the disclosed subject matter may become more apparent from the detailed description set forth below when taken in conjunction with the drawings in which like reference numerals indicate like features.

The drawings serve to explain the inventions disclosed herein. For simplicity, it is assumed that the installation is done in the Northern Hemisphere, with a North-South oriented exposure geometry or with East-West geometry. Some nomenclature will be specific to installations, but the concepts may still be transferable to a person with ordinary skill in the art and we consider transferable ideas and embodiments as applying to any installation orientation.

For east-west geometry we may refer to mounting feet as valley feet and ridge feet, for installation of the low edge of the PV frame and the high edge of the PV frame, respectively. We may refer to north and south feet in a north-south oriented installation. However, most often, in north-south facing installations, north and south feet are designed the same, in that north feet of one module become, by installation attachment, the south feet of the adjacent module. Valley feet and ridge feet in east-west installation embodiments are in the more general case, different from each other and significant different features are pointed out. All arrangement geometries are considered captured as part of this invention.

FIG. 1 shows the underside of a PV module with integrated mounting system, with the mounting components collapsed for shipment.

FIG. 2 shows an array of PV modules with integrated mounting systems, installed and interconnected in a north south arrangement, with additional east-west connections and wind deflectors along east, west (not shown) and north edge of said array.

FIG. 3 shows a PV module with integrated mounting system, with a honeycomb structure on the mounting feet for low material usage. Snapping features to keep the mounting components collapsed within the PV module frame and support are highlighted.

FIG. 4 shows an example embodiment of a sideways connection between modules, such as an east-west connection for a north-south arrangement or a north-south connection for an east-west arrangement. Said sideways connection is transported within one panel and is rotated by about 180 degrees (with a range of +/−30 degrees) with respect to the mount support, upon installation and mated to its neighbor panel.

FIG. 5 shows another example embodiment of a sideways connection between modules, such as an east-west connection for a north-south arrangement or a north-south connection for an east-west arrangement. Said embodiment includes a connecting plate and two connecting screws with two regions of segmented circles, both on the connecting plate and on the corresponding connection regions on the module support of two adjacent modules. By having a finely segmented circular region, in a form not unlike a poker chip, a rigid and strong connection can be achieved even across a non-even roof surface that causes the two adjacent PV modules to not be exactly parallel.

FIG. 6 shows a wind guard that is employed between two adjacent modules. Said wind guard is shipped in a collapsed mode as part of the module support and can be slid out upon installation, in order to prevent or reduce wind access underneath the modules and thus reduce wind uplift force.

FIG. 7 shows an example for a wind deflector attached to an edge of a module array, wherein said deflector extends into the walkway area between modules.

FIG. 8 shows example cable management solutions to achieve easy and comfortable connection between adjacent modules. Cable routings from junction box along the support frame ribs or brackets and to the module support are shown. Connectors installed in pigtail formation for transport and installation preparation are shown. Details of cable holding features are highlighted.

FIG. 9 shows an example electrical module connection between adjacent modules, wherein the cable is supported, at least on one side, by a hook in the module frame or in the module frame sideways connector. An asymmetric cable exit from the module support allows connection flexibility and easy polarity reversal where needed, while retaining easy cable suspension from the ground.

FIG. 10 shows details of an example cable management as part of a PV module frame and PV module support. Module to module connectors are shown, together with home run cables attached neatly to the module supports and held by flexible clamps to said module supports.

FIG. 11 shows another embodiment of flexible clamps for home run cable management between panels.

FIG. 12 shows another embodiment in which flexible clamps for homerun installation are part of the module frame.

FIG. 13 shows a PV module panel, with a snow load support snapped in place into the frame ribs or brackets of the PV module for transport, then unsnapped and ready to be snapped into prepared receiving holes near the center of the panel, by the PV panel handle. Also shown is a side view of said panel, with the snow mount attached and in place.

FIG. 14 shows a snow mount concept, with said snow mount snapped to the frame in a transport location, then removed from said location and turned 90 degrees for installation, then snapped into place. A side view of said panel, with the snow mount attached and in place, is also shown.

FIG. 15 shows another snow mount concept. With two snow mounts per panel, each folded and snapped into a transport location to be flush or nested within the frame. For installation, said snow mounts are unsnapped from their holding location, turned and snapped into prepared locations to support the snow load underneath the panel, and thereby providing a central mechanical support of the photovoltaic system.

FIG. 16 shows another snow mount concept, wherein two wedge shaped supports are shipped separately from a PV module with mounting frame and are attached upon installation. Said mount wedges can be designed to be highly stackable and when designed correctly, can take the whole weight of the PV module, making further panel support not necessary, especially when combined with a further connection.

FIG. 17 shows a PV module frame concept, wherein a cold formed metal (e.g. steel or aluminum) profile is integrated into a polymeric or fiber reinforced polymeric frame for increased strength, while keeping additional cost and complexity low.

FIG. 18 shows various PV module frame and support concepts, with one concept showing a full frame with four additional support ribs or brackets and a handle between the inner ribs or brackets, another concept showing the same but the frame along the short edges reduced to a thin strip to merely protect the glass edge of the PV module laminate. A third concept contains a full frame support, but only two inner support ribs or brackets with a connecting bar that can serve as a handle during transport and installation.

FIG. 19 shows PV modules with integrated racking system, said modules ideally to support an east-west connection array with high ground cover ratio. Said PV modules have two different types of panels, with a Type A and a Type B, wherein one type of panels serves to incline the PV module surface towards the east, the other type towards the west and wherein panels are connected each via valley feet arrangements along their respective lower edges and connected via ridge feet arrangements along their respective upper edges.

FIG. 20 shows detailed features of a type of panel which contains the valley feet. Said valley feet are snapped in place in a transport location to be nested into the PV frame and unsnapped for installation. Also shown is a temporary valley lifting support which helps in the preparation of the installation area. Said temporary support is tucked in for transportation.

FIG. 21 shows the underside of a PV module with mounting frame, with a temporary valley lifting support unfolded and in place at the time of installation.

FIG. 22 shows a PV module with mounting system, with a temporary valley lifting support engaged to prop up the valley edge of said PV module. Cross sections of said PV module are shown, with the valley foot tilted upward to give access to clean and prime the location where the valley foot is to be attached to the roof.

FIG. 23 shows the valley edge of a PV module with mounting frame, with hooks that attach to a valley foot as well as the valley foot itself for clarity. It can be seen that hooks engage in slots and hook underneath a crossbar.

FIG. 24 shows two valley edges of adjacent modules, together with a valley foot, wherein one module is already fully engaged in said valley foot and the other module is in the process of being placed into said foot. For illustration purpose, the hooks of the adjacent panel are not engaged in the cross bar yet. But it is apparent that both modules use the same cross bar but use alternating slots. Slots are used to guide the hooks into the right place, as the installer may have poor visibility when the hooking installation takes place.

FIG. 25 shows the cross section of the valley connection between panels and illustrates how panels are swung into place and as the adjacent panel swings down, the hooks engage solidly in the jointly used crossbar. This arrangement assures very tight mounting and enables a high ground cover ratio.

FIG. 26 shows the process of engaging the adjacent valley panel. For illustration purposes the PV panel is not shown, only its frame with attached hooks. In addition, a valley foot design with a honeycomb structure for good strength at minimize material usage is indicated.

FIG. 27 illustrates the onset of engaging an adjacent panel to an already installed panel along the valley edges of said panels. It is apparent how hooks of the adjacent panel are guided in for easy and straightforward installation. Said slotting also is used to give strength to the polymeric or fiber reinforced polymeric valley foot.

FIG. 28 shows one embodiment of a ridge foot installation for an east-west PV module arrangement. A module support is tilted in place, near vertically. For surface priming, a connecting ridge foot is tilted up to give access to the ground below. A rib on the outside of the tilting joint assures that the ridge foot can be tilted without shifting or misaligning the module, as the foot does not need to displace the module mount for the tilting up or down action.

FIG. 29 shows the ridge mounting foot in another embodiment, with additional ribs for strength. Along the ridge foot edge that is facing towards the adjacent module a slot or pocket is visible, into which the mount support of the adjacent module of other type can be snapped upon installation.

FIG. 30 shows the installation of an adjacent module, along the ridge edge of the east-west PV module arrangement. The adjacent module to be installed has its mounting support tilted out to be snapped into place and mated with the ridge foot of the already installed module. Open regions in both modules' mount supports leave room for the installers' feet and thus make it easy for the installer to act in a balanced way, even when walking along a very narrow pathway between modules.

FIG. 31 shows another example embodiment for an east-west installation concept using PV modules with integrated mounting systems. A set of modules, stacked tightly for transportation, is shown, only for illustration purposes the stack is shown from below. In addition, a valley foot is shown. Said valley feet are typically shipped separately for this embodiment.

FIG. 32 shows an east-west installation concept for PV modules. Shown is a first row of modules, with aligned valley edges and with mount supports folded out.

FIG. 33 shows an east-west installation concept for PV modules. Shown is the state where the installer primes and cleans the area under each foot and connects the modules electrically.

FIG. 34 shows an east-west installation concept for PV modules. Shown is the process where each foot is rotated into place and attached to the roof surface.

FIG. 35 shows an east-west installation concept for PV modules, with the array viewed from different angle. Shown is the state where the valley edge is lifted for priming and the valley foot is attached.

FIG. 36 shows an east-west installation concept for PV modules. In this arrangement, ridge feet are not shared but can be overlapped or snapped together. So, for this arrangement, a system with just one type of panels is envisaged. Shown is the state where the adjacent second module row along the ridge is aligned to the first row.

FIG. 37 shows an east-west installation concept for PV modules. In this state, the ridge feet of the second row are lifted and the area is cleaned and primed for adhesion.

FIG. 38 shows an east-west installation concept for PV modules. In this state, the adhesive liner of the ridge feet of the second row is removed and the feet are placed and adhered to their position. Module interconnection and home run cable placement can now happen.

FIG. 39 shows an east-west installation concept for PV modules. In this state, the valley feet are set, in order to connect the next row along the respected valley edges. Said valley feet can be shipped separately or be included in the modules for shipment. The areas of the valley feet are cleaned or primed and valley feet are adhered into place. Thus, the connector can be shipped as part of the frame and can be rotated in place upon installation, to connect with a neighbor panel.

FIG. 40 shows an east-west installation concept for PV modules. In this state, the next adjacent panel is hooked into place by rotating its valley edge hooks into receiving valley feet.

FIG. 41 shows an east-west installation concept for PV modules. The next row is fully in place and the process can be repeated.

FIG. 42 shows another concept for an east-west installation arrangement for PV modules. In this arrangement, a mount support of one panel is nested in for shipment, rotated out for installation, feet are either attached or rotated into place after priming the area where the feet go, if the installation is for an adhesive attachment. Then, along their respective ridges, an adjacent panel is slid into place and attached. For that, the surfaces of the mount supports can be equipped with T-type connection slots for good interlocking. The peak of the modules is still accessible for cable routing along the ridge.

### DETAILED DESCRIPTION

This disclosure presents various practical solutions for greatly simplified installation of PV modules, mainly based on the use of polymeric or fiber reinforced polymeric or metal rail and fiber reinforced polymeric structures with specific features, often using rotation and snapping concepts to install PV modules on rooftop without the use of tools.

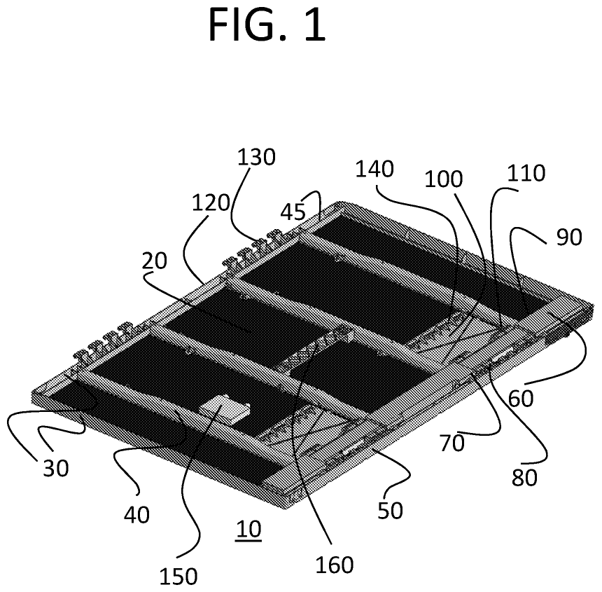

FIGS. 1-5 focus on installations enabling sound and rigid array connections between modules while being able to easily accommodate uneven roof surfaces.

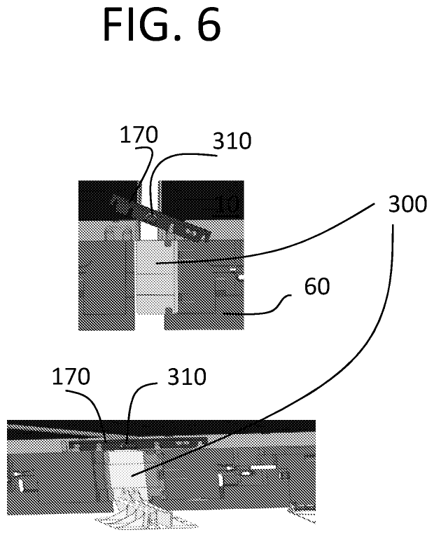

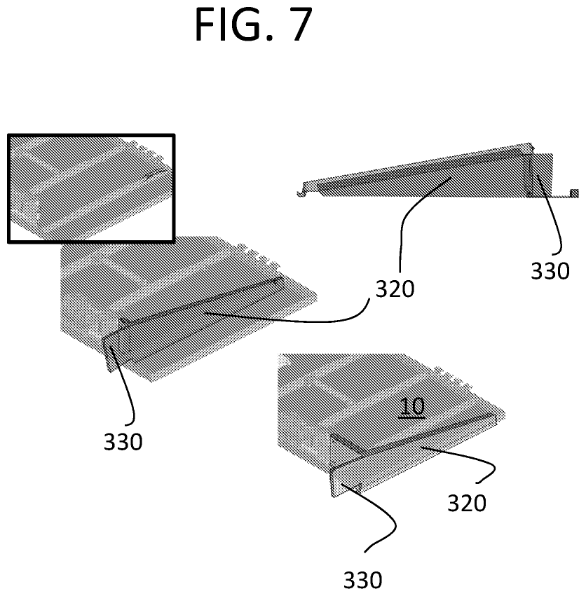

FIGS. 6 and 7 illustrate some wind deflection concepts.

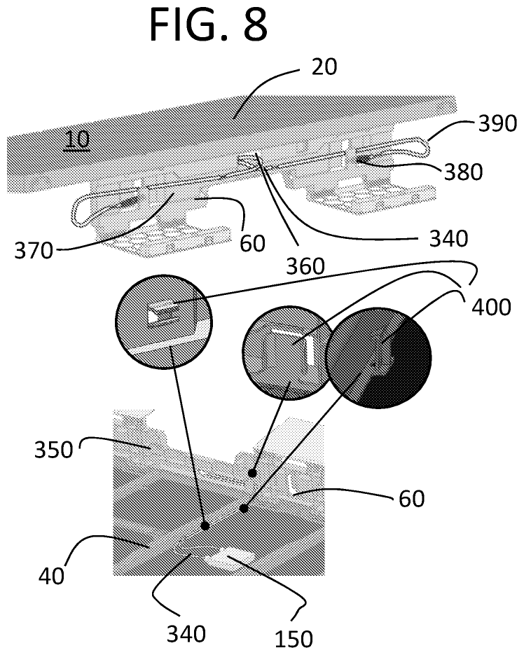

FIGS. 8-12 teach various modes of cable management which all enable significant time savings for installation, while achieving electrical connections with superior cleanliness, solidity and accessibility.

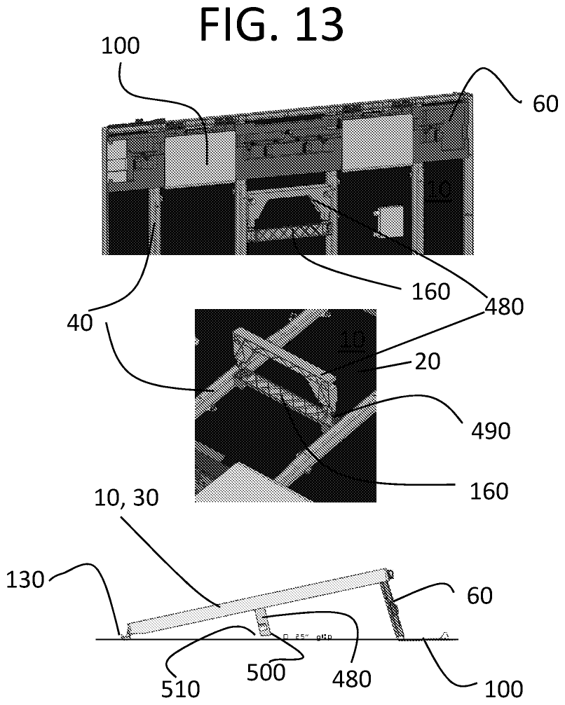

FIGS. 13-16 introduce concepts to achieve superior snow load resistance for panels.

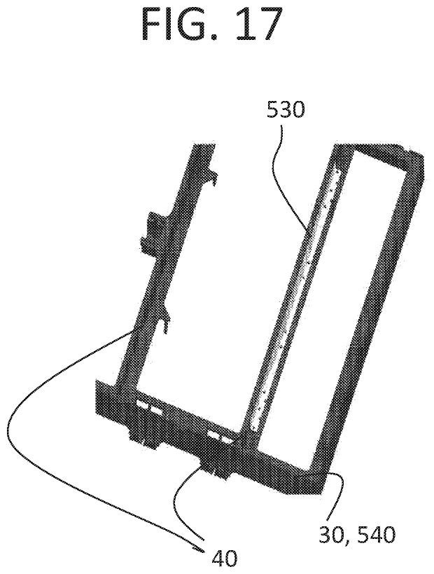

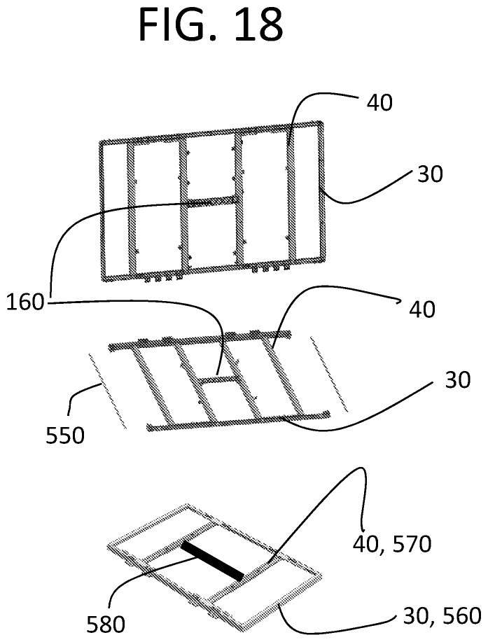

FIGS. 17-18 present concepts for reducing frame weight and cost for co-optimized economics and frame strength.

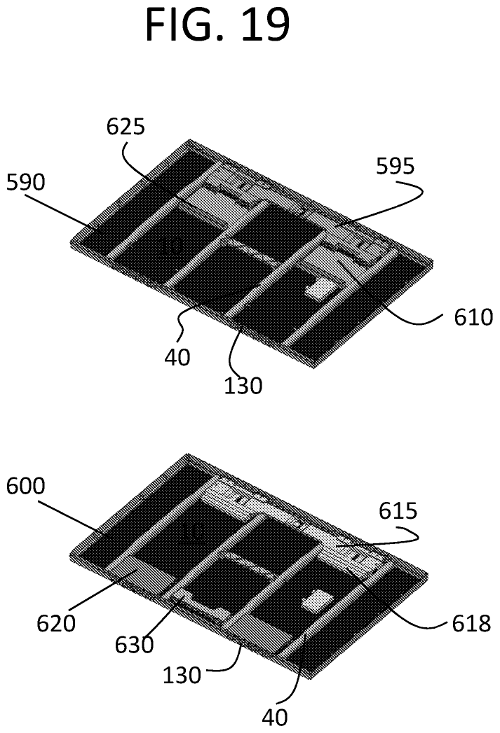

FIG. 19-30 show an exemplary east-west PV module arrangement concept, based on two similar but slightly differently configured module types.

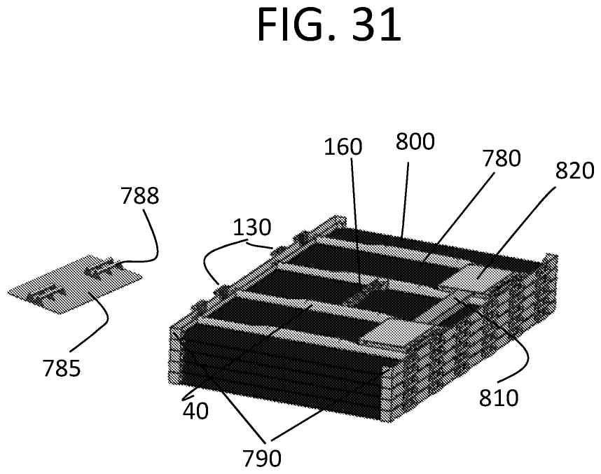

FIGS. 31-41 shows another exemplary east-west PV module arrangement concept utilizing one type of PV module plus a specific valley foot.

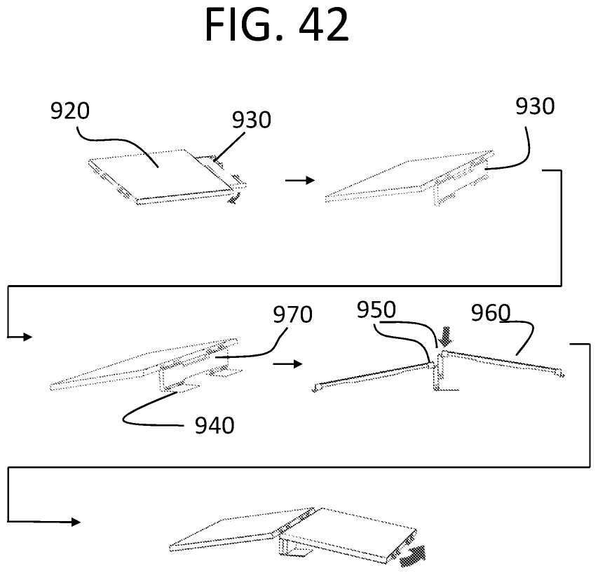

FIG. 42 shows yet another exemplary east-west PV module arrangement concept wherein the modules are connected closely along their ridges.

FIG. 1 shows the underside of a PV module with integrated mounting system 10, with the mounting components collapsed for shipment. PV laminate or PV module 20 is attached, for instance via an adhesive, to mounting frame 30 and its support ribs or brackets 40, said mounting frame being essentially rectangular, but with optionally rounded off or chamfered edges. Along the inner edge of mounting frame 30 is a ledge 45 which serves as support for adhesive that is used to adhere PV laminate 20 to mounting frame 30 and which also provides mechanical support to said PV laminate upon snow loading and other deflecting load cases, such as wind loading or module flexing upon installer handling. Along the edge that will be installed higher edge 50 (ridge edge for east-west or North edge for north south configuration), mount support 60 is attached which is folded in and is nested within the outlines of the module mounting frame 30 for shipment. The mount support is preferably attached along its upper edge 70 to said higher edge 50 of the mounting frame using hinges 80, along which it can be rotated out for installation. The mount support is adapted to raise one side of the PV laminate, and is rotatably attached to the mounting frame along one edge by hinges. The mount support is configured to be rotatable to and from a nested position within the mounting frame. Attached to the lower edge 90 of the mount support 60 are mount feet 100, which are connected to the lower edge 90 of the mount support via hinges 110 along the lower edge of the mount support. For transport and stacking, said mount feet are rotated away from the mount support and are nested within the outlines of the frame 30, preferably nested between support ribs or brackets 40 of mounting frame 30 and preferably snapped to support ribs or brackets 40 or to the back side of PV laminate 20. Upon installation, said mount feet are rotated out and into position using hinges 110. Along the edge 120 that will be installed lower to the ground, (the south edge for north-south installation or the valley edge for an east-west installation) are mounting hooks 130 which attach to the mount feet 100 of a neighboring module, across from the hinges 110 of said mount feet 100, via a hook attachment bar 140. Said mount feet 100 can be attached to a rooftop via an adhesive, which can itself be pre-attached to the bottom side of the foot and protected using a liner which is peeled off by the installer immediately prior to installation. The mount foot can also serve as a pad upon which ballast can be applied, in case a ballasted installation is preferred. It can also be devised to have holes pre-drilled which allow foot attachment by roof penetration and tiedown.

Also shown in the figure are junction box 150 and PV module handle 160, which is preferably attached to said support ribs or brackets. The support ribs or brackets, and the whole structure including ledge 45 provide, at comparatively low weight, additional support for the PV laminate, especially when compared to standard PV module aluminum frames, thereby enabling the use of thinner glass and thus enabling overall lighter system weight.

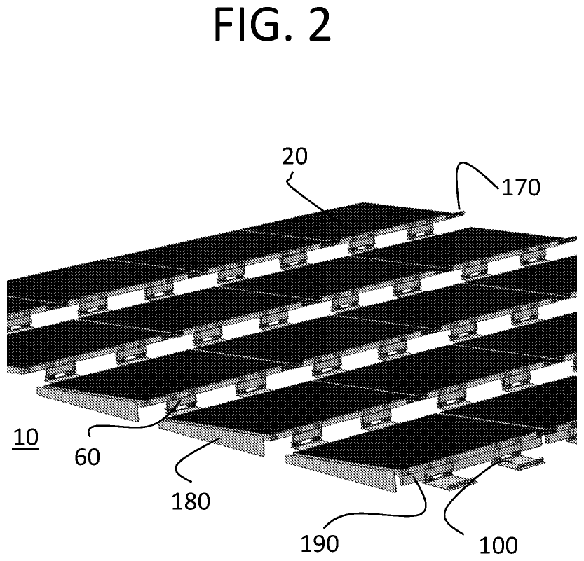

FIG. 2 shows an array of PV modules with integrated mounting systems 10, installed and interconnected in a north-south arrangement, with additional sideways connection bars 170, here used as east-west connectors in this north-south arrangement, and wind deflectors 180 along east, west (not shown) and wind deflectors 190 along the north edge of said array. The figure illustrates how mount support 60 and mount feet 100 have been rotated out from their nesting positions within the module frame and are arranged in their installed position.

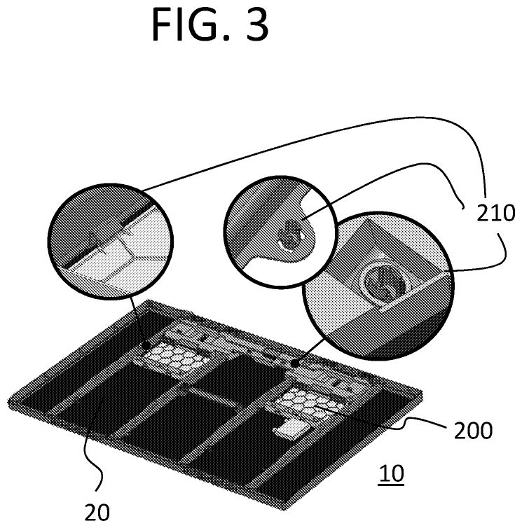

FIG. 3 shows a PV module with integrated mounting system 10, with a honeycomb structure 200 on the mounting feet for low material usage. Different embodiments of snapping features 210 to keep the mounting components collapsed within the PV module frame and support are highlighted. Said snapping features are designed to allow a worker to unfold components for installation, as well as to re-fold for a potential de-installation and subsequent stacking, all without the use of tools.

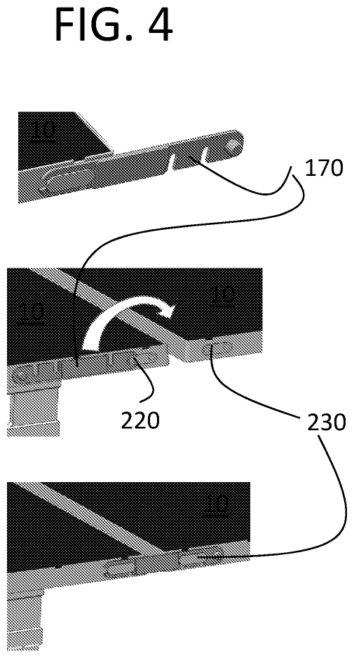

FIG. 4 shows an example embodiment of a sideways connection bar 170 between PV modules with mounting frame 10, such as an east-west connection for a north-south arrangement or a north-south connection for an east-west arrangement. Said sideways connection bar 170 is transported within one panel and is rotated by about or essentially 180 degrees (+/−30 degrees) along swivel axis point 220 upon installation and mated to its neighbor panel to sideways connector attachment position 230.

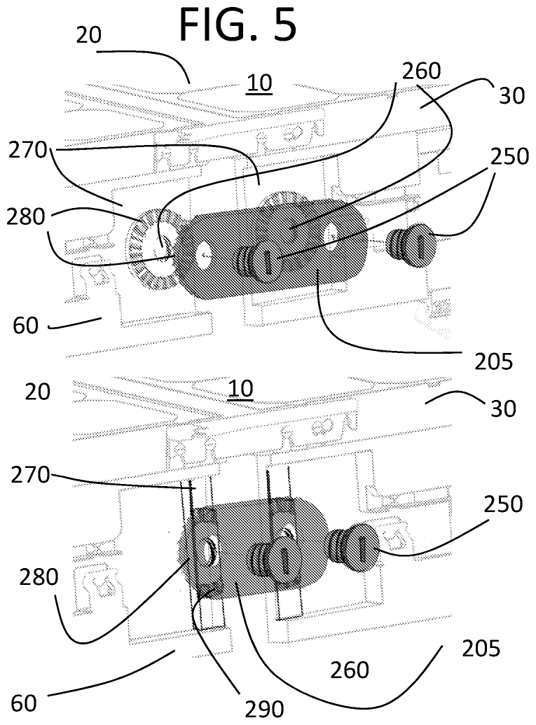

FIG. 5 shows another example embodiment of a sideways connection between modules, such as an east-west connection for a north-south arrangement or a north-south connection for an east-west arrangement. Said embodiment includes a connecting plate or bar 205 which has two circular serrated, “poker-chip” like features or arches on its inner side, and two connecting screws 250, mating via two screw holes 260 at the sideways connector plate attachment location 270 of mount supports 60 of two adjacent PV modules with integrated mounting systems 10, wherein the two attachment locations have corresponding serrated circular “poker-chip” like features 280. By having a finely segmented serrated circular region, in a form not unlike a poker chip, a rigid and strong connection can be achieved even across a non-even roof surface that causes the two adjacent PV modules to not be exactly parallel as each module conforms with the roof surface. Such a rigid and strong connection between neighboring modules allows for the transfer of hold-down forces between neighboring modules. Said connections allow for contribution of hold-down forces from neighboring modules to a specific module to increase the hold-down of said specific module in conditions where said specific module is exposed to wind-uplift forces. The two examples in FIG. 5 show embodiments with full circular serrated patterns for the upper image or, for space savings, in the lower image, just with segments of a circle 290 on the attachment location devised as having the serrated features. Also shown in this image is the sideways connection bar 170 that is attached on the mounting frames 30 of the PV modules 10.

FIG. 6 shows a wind guard 300 that is employed between two adjacent PV modules with integrated mounting systems 10. Said wind guard is shipped in a collapsed mode as part of the module mount support 60 and can be slid out upon installation, in order to prevent or reduce wind access underneath the modules and thus reduce wind uplift force. Also shown is a sideways connector bar 170, with a hook feature 310 which may serve to hold up cables connecting adjacent modules. It is apparent that if the connecting cables are held up by said hook feature 310, then the wind guard can be slid into place even when cables are already connected.

FIG. 7 shows an example for a side wind deflector 320, attached to an edge of an array of PV modules with integrated mounting systems 10, wherein said deflector has an extension bar 330 into the walkway area between modules. Different illustrations point out different locations where said wind deflector can be attached to the PV module frame 30 or its support ribs or brackets 40.

FIG. 8 shows example cable management solutions to achieve easy and comfortable connection between adjacent modules. A PV module with integrated mounting system 10 is shown. Cables 340 are routed from junction box 150 along the support frame ribs or brackets 40 and to the inside 350 of module mount support 60. Through a hole 360 in mount support 60, the cables are routed to the outside 370 of mount support 60. Cable connectors 380 are installed in pigtail cable arrangement 390 for transport (factory install) and installation preparation are shown. Details of cable holding features 400 along frame, ribs or brackets and mount support are highlighted. These illustrations show that all the cable routing can be prepared prior to shipment of the modules and upon installation, the installer merely needs to take cable connectors from adjacent modules that are prepared close to each other and connect them. No cumbersome locating and routing of cables are required at the installation site. Thus, the exemplary integrated cable management solutions utilizes cables from a junction box mounted on the PV laminate and preassembled so as to be routed along the PV mounting frame, brackets or ribs to mount supports, with the cable connectors configured to be factory installed about regions where neighboring modules are connected.

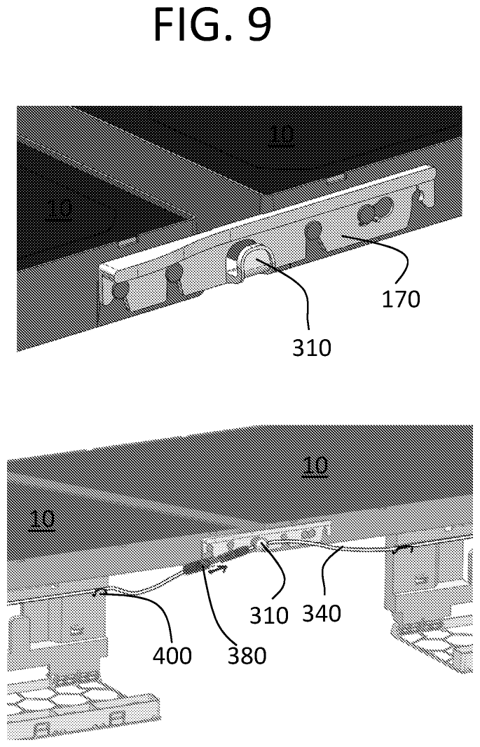

FIG. 9 shows an example electrical module connection between adjacent PV modules 10, wherein the cables 340 are supported, at least on one side, by a hook feature 310 in the module frame or in the module frame sideways connector bar 170. Cable holding features 400 in the mount support are also shown. The hook feature 310 reduces the free unsupported span of the cable and thus the pull on the cables 340 and cable connectors 380. An asymmetric cable exit from the module support allows connection flexibility and easy polarity reversal where needed, while retaining easy cable suspension from the ground.

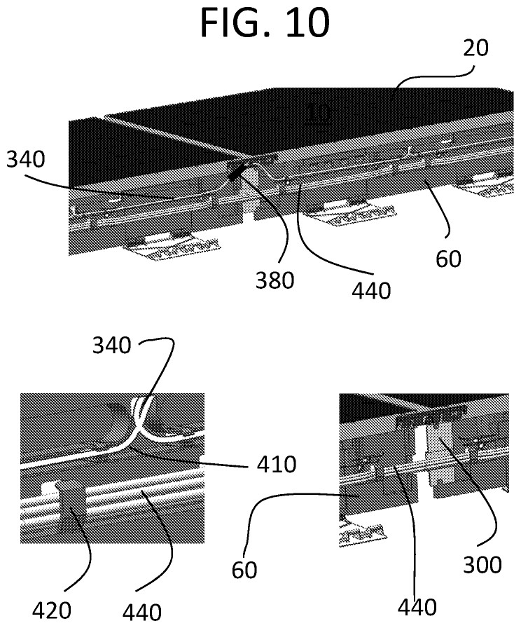

FIG. 10 shows details of an example cable management as part of a PV module frame and PV module support. Cables 340 from the Junction boxes are routed in channels 410 containing cable clips 420, wherein said channels are in the mount support structure 60. Cables from junction box are connected to adjacent modules using connectors 380. Also shown are additional clips 430 in the mount support 60, which hold the homerun cables 440, which span across several modules. The clean and neat arrangement at good ergonomic access for installation and maintenance is apparent. Also shown is the capability to open or close sliding wind guard 300, even with interconnecting cables and homeruns installed.

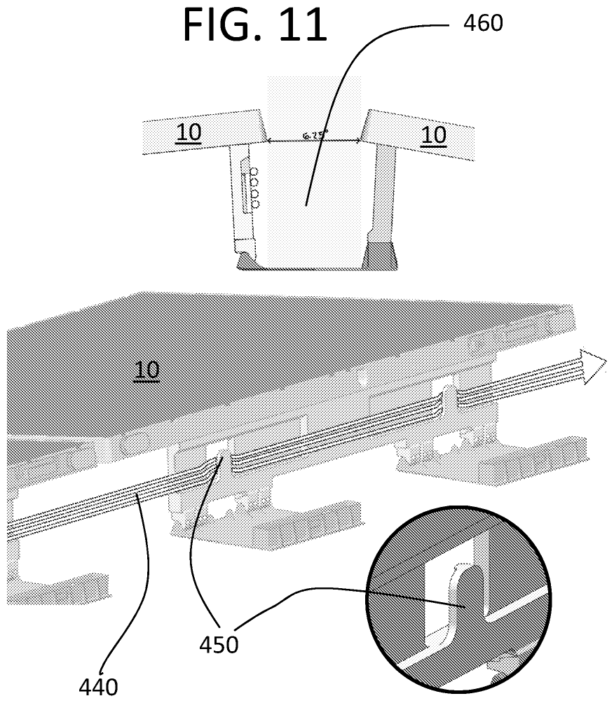

FIG. 11 shows another possible embodiment of flexible clamps or clips 450 for home run cable 440 management between PV panels 10. The cross section, which is typical for an east-west panel arrangement where ridges of panels face each other, shows a minimized topography for said homerun cables. Cables do not protrude into walkway 460.

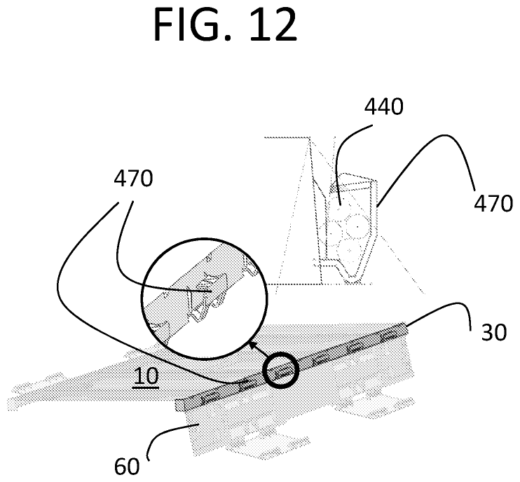

FIG. 12 shows another embodiment in which flexible clamps 470 for homerun cable 440 installation and management are part of the module frame 30 of the PV module with integrated mounting system 10.

FIG. 13 shows a PV module panel with integrated mounting system 10, with a snow load support 480 snapped in place via a snap feature 210, such as shown in other figures, into the frame support ribs or brackets 40 of the PV module 10 for transport, then unsnapped and ready to be snapped into prepared receiving holes 490 near the center of the panel, for instance arranged close to the or as part of the PV panel handle 160 and ideally attached to support ribs or brackets 40, such upon deflection and engagement of the snow load support, the load support is uniformly distributed across the PV laminate's back surface across support ribs or brackets 40. Also shown is a side view of said panel, with the snow load support 480 attached and in place. Also shown is the slanted lower edge 500 of the snow mount and the small gap 510 between the lower edge of the snow mount and the rooftop. By using such a small gap, the snow mount is only engaged and provides support to the center of the PV laminate 20 when a present load deflects the panel downwards.

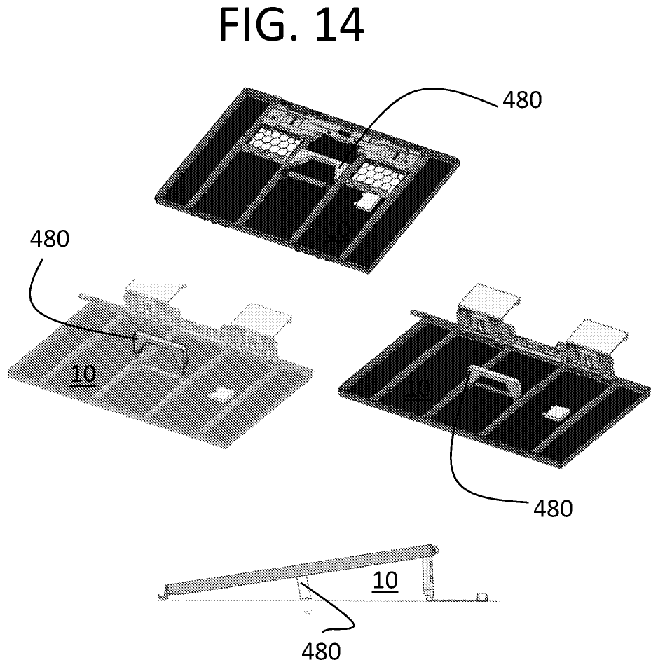

FIG. 14 shows essentially the same snow load support 480 concept, but for a different embodiment of a PV module with integrated mounting system 10. Shown here are all stages with said snow load support 480 snapped to the frame in a transport location, then removed from said location and turned about 90 degrees for installation, then snapped into place. A side view of said panel, with the snow mount attached and in place, is also shown.

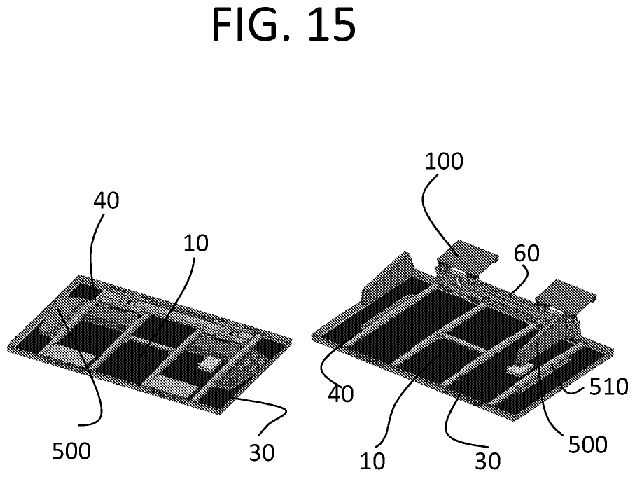

FIG. 15 shows another snow mount concept. With two low-profile wedge-shaped snow load supports 500 per panel, each with small enough profile to be snapped to and nested within the PV module frame 30 or its ribs or brackets 40 in a transport location to be flush or nested within the frame. For installation, said snow mounts are unsnapped from their holding location, turned and snapped into prepared plug- and snap locations 510 to support the snow load underneath the panel.

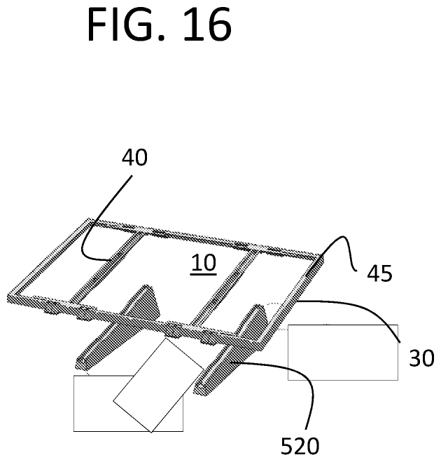

FIG. 16 shows another snow mount concept, wherein two larger wedge-shaped supports 520 are shipped separately from a PV module with integrated mounting system 10 with support frame 30 with ledge 45, containing ribs or brackets 40, and are attached upon installation. Said mount wedges can be designed to be highly stackable and when designed correctly, can take the whole weight of the PV module, making further panel support not necessary, especially when combined with a further connection.

FIG. 17 shows a PV module mounting frame concept, wherein a preferably cold formed metal profile 530 is integrated into a polymeric or fiber reinforced polymeric PV frame 30 or 540, with support ribs or brackets 40 for increased strength, while keeping additional cost and complexity low.

FIG. 18 shows various PV module frame and support concepts, with one concept showing a full PV module frame 30 with four additional support ribs or brackets 40 and a handle 160 between the inner ribs or brackets, another concept showing the same but the frame along the short edges reduced to a thin strip 550 to merely protect the glass edge of the PV module laminate. A third concept contains a full frame support 30 or 560, but only two inner support ribs or brackets 40 or 570 with a connecting bar 580 that can serve as a handle during transport and installation and can also serve to take on and distribute weight into the ribs or brackets in case a snow load support mount is attached to it.

FIG. 19 shows PV modules with integrated racking system 10, said modules ideally to support an east-west connection array with high ground cover ratio. Said PV modules have two different types of panels, with a Type A panel 590 and a Type B panel 600, wherein one type of panels serves to incline the PV module surface towards the east, the other type towards the west and wherein panels are connected each via valley feet arrangements along their respective lower edges and connected via ridge feet arrangements along their respective upper edges. Panel A 590 contains mount support 595 along the ridge and ridge feet 610, which are hinged to mount support 595 and folded in and nested within the PV frame and preferably snapped to support ribs or brackets 40 during transport. Panel A also contains, along its valley side, a set of mounting hooks 130 that are used to engage it to the valley feet of its neighbor panel, panel B. Said Panel B 600 contains mount support 615 along its ridge side, hinged to the ridge part of the frame, and valley feet 620. Said Type B mount support 615 contains a snapping feature 618 along the edge where it connects to the ridge foot 610 of panel 595 Type A. The ridge foot 610 of panel 590 Type A contains, across from the side where it is hinged to mount support 595, a reception area 625 for said mount support 615 of panel 600 of type B. Panel 600 Type B also contains a priming lifter 630 to at least temporarily lift the valley side of the panel, prior to attaching valley feet to the rooftop surface. For stacking and transport, all mounting features are tucked in and nested within the geometry of each frame.

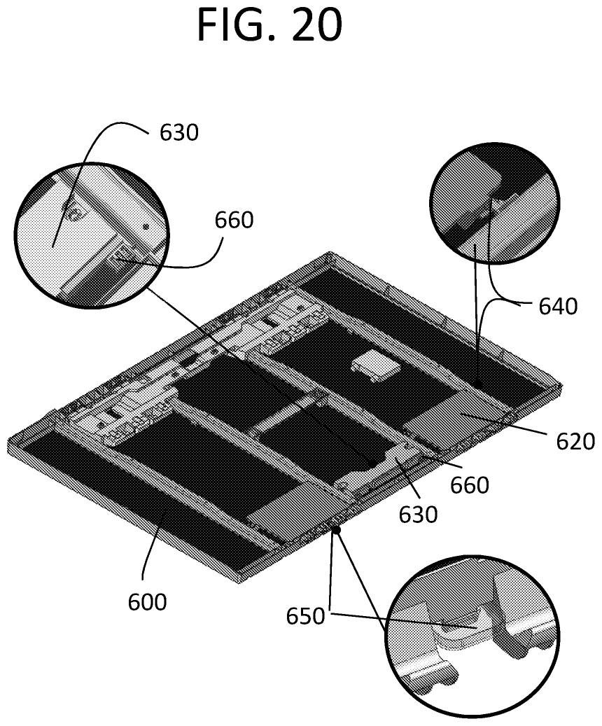

FIG. 20 shows detailed features of the type of panel 600 which contains the valley feet 620. Said valley feet are snapped or hooked in place using snap or hook feature 640 in a transport location to be nested into the PV frame and unsnapped for installation. A lip 650 helps the installer to easily unsnap the valley foot from the frame at the time of installation. Also shown is a temporary valley lifting support 630 which helps in the preparation of the installation area. Said temporary support is tucked in for transportation and is hinged at hinge location 660 to the frame support ribs or brackets.

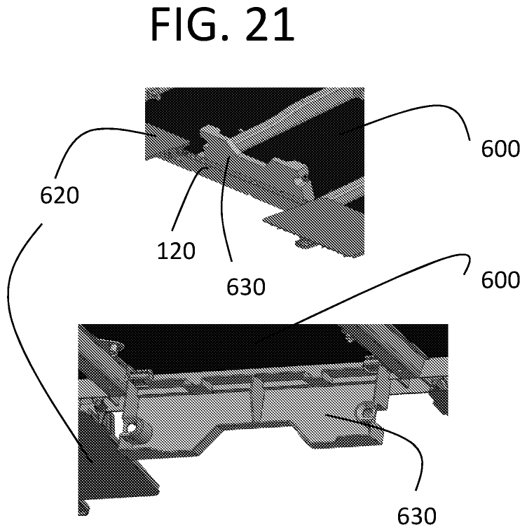

FIG. 21 shows the underside of a PV module with mounting frame 600 containing valley feet 620, with a temporary valley lifting support 630 unfolded and put in place at the time of installation, such as to temporarily prop up the valley edge 120 of said module 600.

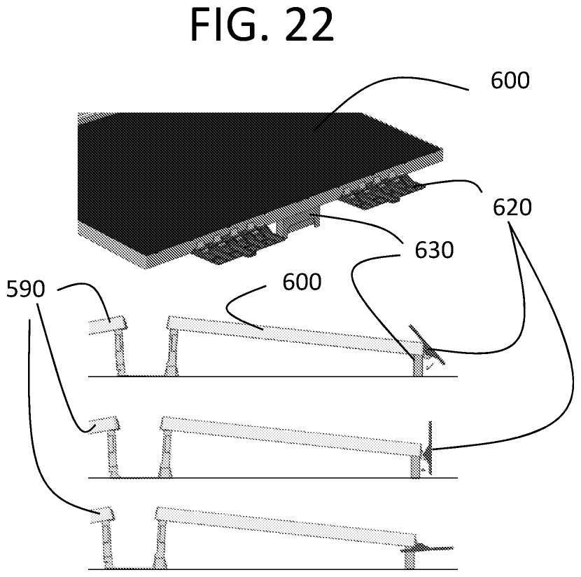

FIG. 22 shows a PV module with mounting system 600, with a temporary valley lifting support 630 engaged to prop up the valley edge 120 of said PV module. Cross sections of said PV module are shown, with the valley foot 620 tilted upward to give access to clean and prime the location where the valley foot is to be attached to the roof. After cleaning and priming the valley edge is then lowered to adhere the valley foot to the roof.

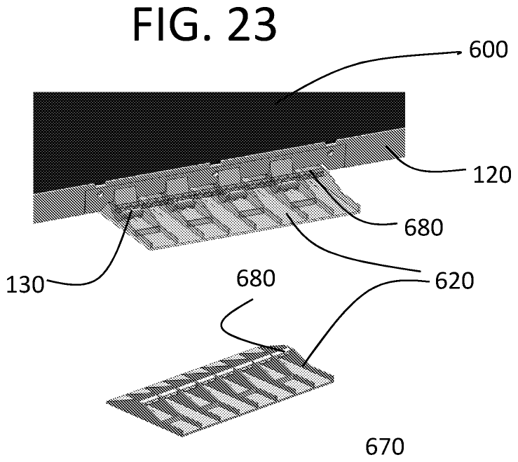

FIG. 23 shows the valley edge 120 of a PV module with integrated mounting system 600, with mounting hooks 130 that attach to a valley foot 620. Also shown is the valley foot 620 itself for clarity. Mounting hooks 130 engage in slots 670 that guide the hooks and the hooks are engaged underneath a crossbar 680 of valley foot 620.

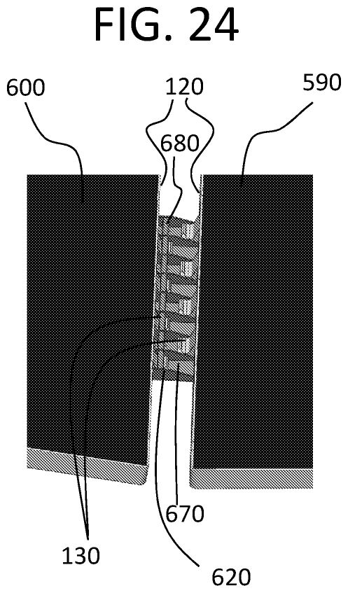

FIG. 24 shows two valley edges 120 of adjacent modules 600 and 590, together with a valley foot 620, wherein one module 600 is already fully engaged to valley foot 620 via crossbar 680 and the other module 590 is slid into said valley foot. For illustration purpose, the hooks of the adjacent panel are not engaged in the cross bar 680. But it is apparent that both modules use the same cross bar but use alternating slots 670. Slots are used to guide the hooks into the right place, as the installer may have poor visibility when the hooking installation takes place.

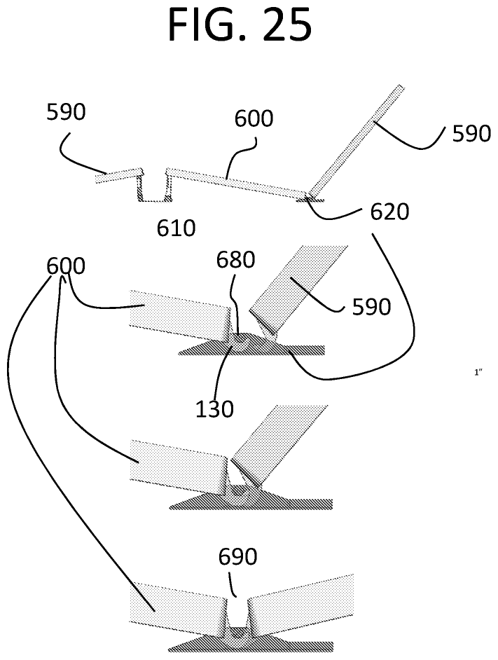

FIG. 25 shows the cross section of the valley connection between panels 600 and 590 via valley foot 620 and illustrates how panel 590 is swung into place. As the newly to be engaged panel swings down, the mounting hooks 130 engage solidly in the jointly used crossbar 680 of valley foot 620. This arrangement assures very tight mounting with a small valley gap 690 between adjacent modules and enables a high ground cover ratio.

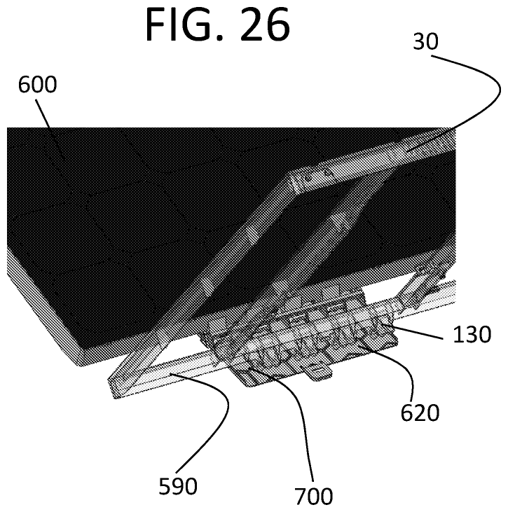

FIG. 26 shows the process of engaging the adjacent valley panel 590, with PV panel 600 and valley foot 620 already installed. For illustration purposes the PV laminate in PV panel 590 is not shown, only its frame 30 with attached mounting hooks 130. In addition, a valley foot design with a honeycomb structure 700 for good strength at minimize material usage is indicated.

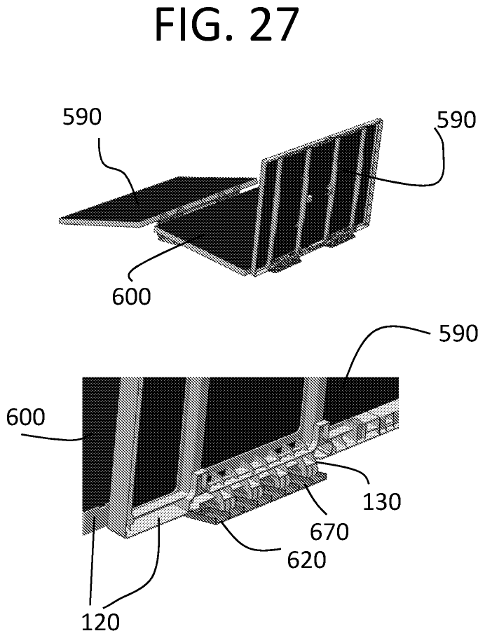

FIG. 27 illustrates the onset of engaging an adjacent panel 590 to an already installed panel 600 along the valley edges 120 of said panels. It is apparent how mounting hooks 130 of the adjacent panel 590 are guided in for easy and straightforward installation along slots 670 in valley foot 620. Said slotting also adds strength to the polymeric or fiber reinforced polymeric valley foot 620.

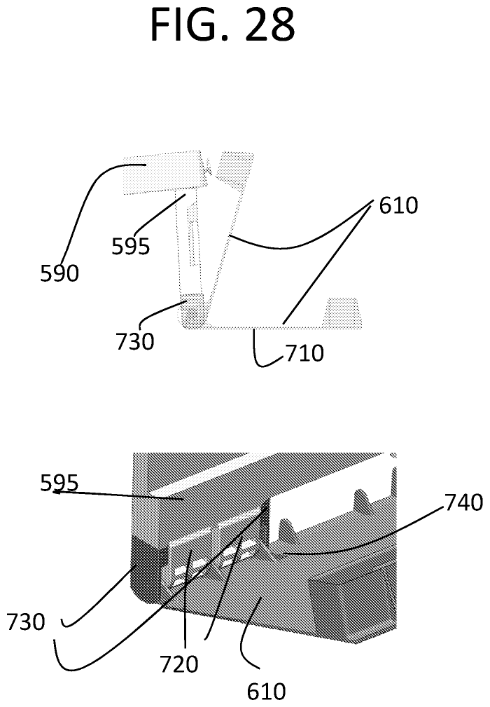

FIG. 28 shows one embodiment of a ridge foot 610 installation for an east-west PV module arrangement. A module support of a panel 590 Type A is tilted in place, near vertically. For surface priming, a connecting ridge foot 610 is tilted up to give access to the ground below at position 710. For illustration, the figure shows ridge foot 610 tilted up for cleaning and priming area 710 and shows ridge foot 610 in its installed flat position. Also shown is the hinge 720 of mount support 595, around which ridge foot 610 is rotated An inner and outer rib 730 on the outside of the tilting hinge joint 720 assures that the ridge foot 610 can be tilted without shifting or misaligning the module, as the foot does not need to displace the module mount 595 for the tilting up or down action. It is to be noted that ridge foot 610 contains a notch 740 in the region of the inner rib 730 to accommodate tilting.

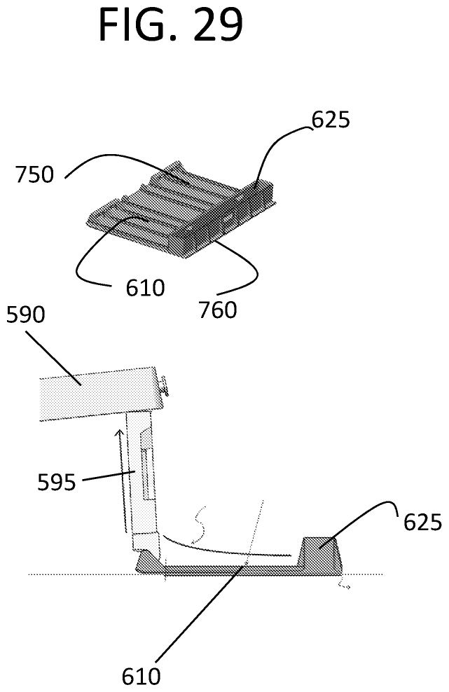

FIG. 29 shows the ridge mounting foot 610 in another embodiment, with additional ribs 750 for strength. Along the ridge foot edge 760 that is facing towards the adjacent module 600 Type B, a slot or pocket feature 625 is visible, into which the mount support 615 of the adjacent module 600 Type B (not shown in this figure) can be snapped upon installation.

As a note: For adhesive installation, the underside of ridge foot 610 can contain an adhesive, which can be protected by a liner that is removed immediately prior to installation. On the other hand, for ballasted installation, it is envisioned that the same ridge foot can be weighed down by ballast pavers, wherein the ridge foot then advantageously can have lips or pins around its edges which secure a paver or pavers in place.

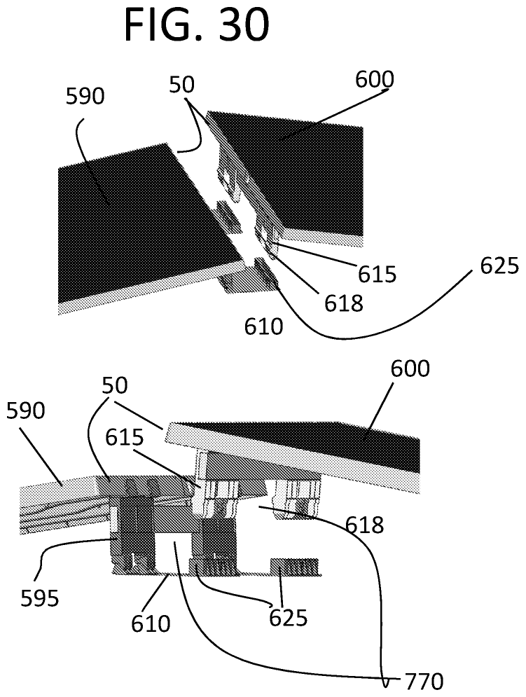

FIG. 30 shows the installation of an adjacent module 600, type B, along the ridge edge 50 of the east-west PV module arrangement. A panel 590 of Type A has already been installed and its ridge foot 610 has been deployed. The adjacent module 600, type B, to be installed has its mounting support 615 tilted out to be snapped into place and mated along its barbed snapping features 618 with the snapping receptacle 625 on the ridge foot 610 of the already installed module 590. Open regions 770 in both modules' mount supports 595 and 615 leave room for the installers' feet and thus make it easy for the installer to act in a balanced way, even when walking along a very narrow pathway between modules 590 and 600, said pathway defined in width by the clear width of ridge foot after installing both module's mount supports 595 and 615.

FIG. 31 shows another example embodiment for an east-west installation concept using PV modules with integrated mounting systems. A set of modules, stacked tightly for transportation, is shown, only for illustration purposes the stack is shown from below. In addition, a valley foot is shown. Said valley feet are typically shipped separately for this embodiment. The illustrated PV modules with integrated mounting system in this embodiment 780 contain, along their valley edges, a set of mounting hooks 130 that can be hooked to a valley foot 785 by means of one or more hook attachment bars 788, said foot typically being shipped separately and shown not-to-scale in this illustration. Also shown is a PV module frame 790 with support ribs or brackets 40, but with reduced coverage along the short edges 800. Along the ridge edge, a mount support 810 is hidden in this image, since it is folded in and ridge feet 820 are folded and nested within said mount support. A handle 160 is attached to support ribs or brackets 40 and can be used for carrying PV module 780. Thus, there is shown a mount foot with hook attachment bar having hooks along the edge opposed from the edge holding the mount support, wherein the hooks are attachable to the hook attachment bar of a neighboring like photovoltaic system, and where the hook attachment bar allows for arranging the neighboring photovoltaic system in a mirror orientation to the photovoltaic system.

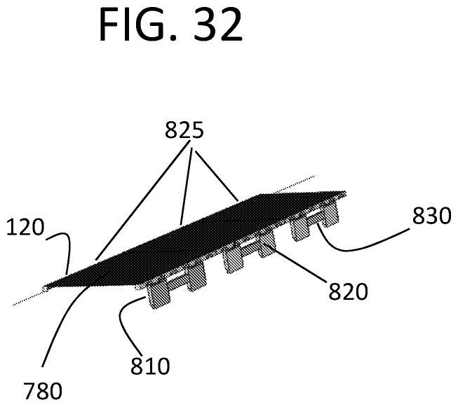

FIG. 32 shows an east-west installation concept for PV modules, using PV modules 780 with features introduced in the previous figure. Shown is a first row 825 of modules 780, valley edges 120 aligned and mount supports 810 folded out, with ridge feet 820 still nested or snapped to said mounts supports 810. Connecting bar 830 can be used by the installer to rotate the mount support into place with one hand.

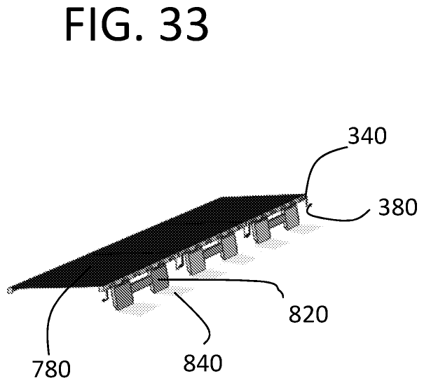

FIG. 33 shows an east-west installation concept for PV modules, using same PV modules 780 with features as in the previous figure. Shown here is the state where the installer primes and cleans the area 840 under each ridge foot 820 and connects the modules electrically. Cables 340 and cable connectors 380 are shown.

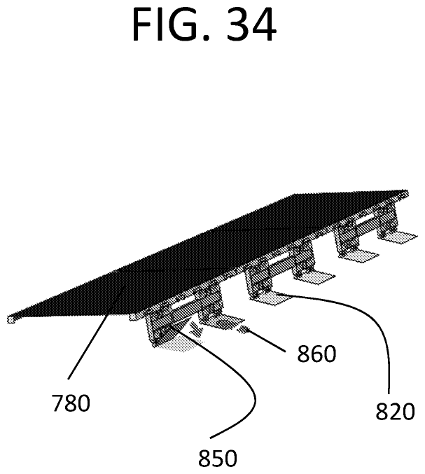

FIG. 34 shows an east-west installation concept for PV modules, using same PV modules 780 with features as in the previous figure. Shown is the process where each ridge foot 820 is rotated into place and attached to the roof surface. It is to be noted that for an adhesive installation, the underside 850 of each said ridge foot 820 can contain an adhesive layer, preferably protected prior to installation by a protective liner which the installer removes immediately prior to installation, which is prior to rotating the foot in place and pressing on the foot, as shown for instance by installer foot print 860, for best adhesion.

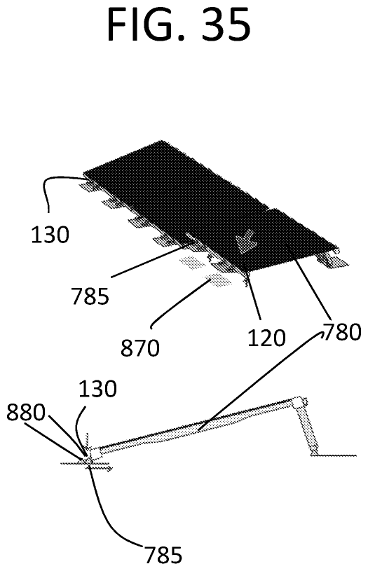

FIG. 35 shows an east-west installation concept for PV modules, with the array viewed from different angle, using same PV modules 780 with features as in the previous figure. Shown is the state where the valley edge 120 is lifted for priming and cleaning in the attachment area 870 and the valley foot 785 is attached to panel 780 via mounting hooks 130 and rotated into place. The left figure shows an example wherein this valley foot contains two crossbar hinges 880 to receive the mounting hooks 130.

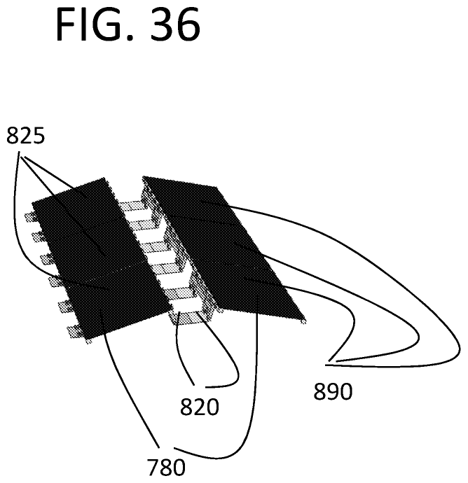

FIG. 36 shows an east-west installation concept for PV modules, using same PV modules 780 with features as in the previous figure. In this arrangement, ridge feet 820 are not necessarily shared between adjacent modules but can be overlapped, snapped together or at least aligned to each other. All in all, for this arrangement, a system with just one type of panels 780 is envisaged. Shown is the state where the adjacent second module row 890 along the ridge is aligned to the first row 825. For alignment, ridge feet 820 of the second row 890 of modules 780 are not glued into place yet.

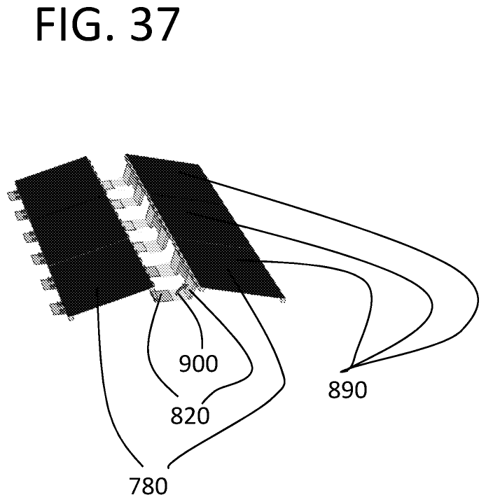

FIG. 37 shows an east-west installation concept for PV modules, using same PV modules 780 with features as in the previous figure. In this state, the ridge feet 820 of the second row 890 of PV modules 780 are lifted and the attachment area 900 of said ridge feet of the second row of modules is cleaned and primed for adhesion.

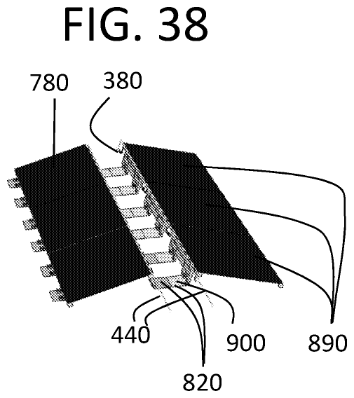

FIG. 38 shows an east-west installation concept for PV modules, using same PV modules 780 with features as in the previous figure. In this state, the adhesive liner of the ridge feet 820 of the second row 890 of modules 780 is removed and the feet are placed and adhered to their position 900. Module interconnection using connectors 380 and home run cable 440 placement can now happen.

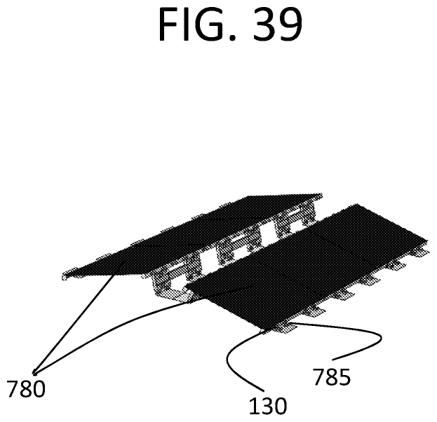

FIG. 39 shows an east-west installation concept for PV modules, using same PV modules 780 with features as in the previous figure. In this state, the valley feet 785 are set, in order to connect the next row along the respected valley edges 120. Said valley feet 785 can be shipped separately or be included in the modules for shipment. The areas of the valley feet are cleaned or primed and valley feet are adhered into place.

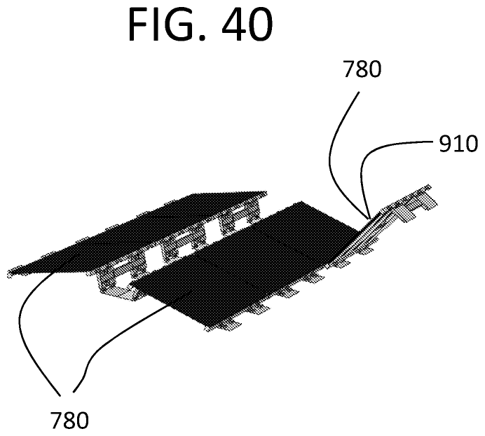

FIG. 40 shows an east-west installation concept for PV modules, using same PV modules 780 with features as in the previous figure. In this state, the next adjacent panel 780 is hooked into place by rotating its valley edge hooks 130 into receiving valley feet 785.

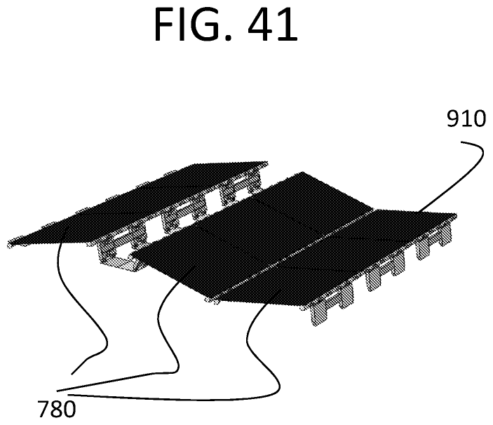

FIG. 41 shows an east-west installation concept for PV modules, using same PV modules 780 with features as in the previous figure. The next, third, row 910 of panels 780 is fully in place and the process can be repeated.

FIG. 42 shows yet another concept for an east-west installation arrangement for PV modules. In this arrangement, a PV panel 920 has a mount support 930 which is either nested in for shipment or turned outwards for a flat, stackable appearance, rotated out for installation. Valley feet, not shown here, as well as ridge feet 940 are either attached or rotated into place after priming the area where the feet go, if the installation is for an adhesive attachment. Alternatively, ridge feet 940 are snapped into place along the lower edge of the mount support. Then, along their respective ridges 950, an adjacent panel 960, which can, but does not need to be identical to first panel 920, is slid into place and attached. For that, the outer surfaces 970 of the mount supports can be equipped with matching T-type connection slots for good interlocking (not shown). The ridge region 950 of the modules is still accessible for cable routing along the ridge. By attaching modules in the way demonstrated in this figure, a large ground cover ratio can be achieved, for servicing panels, panels may need to be lifted, or a walkway along the valley area should be reserved. Alternatively, the arrangement could be done with not every ridge having tightly connected panel mount structures, so that some service walkway areas could be reserved along the ridges as well.

Certain inventions herein are disclosed, in varying level of detail, as part of one or some of the presented embodiments. It is clear to someone with reasonable knowledge of the field to be able to apply or combine features shown in one embodiment to or with features of another disclosed embodiment. Such combinations and transferred application of disclosed concepts are intended to be covered by this enclosure in their entirety.

What is claimed is:

1. A photovoltaic system, comprising:
a photovoltaic (PV) module laminate attached to a photovoltaic mounting frame, said mounting frame having essentially a rectangular shape;
one or more brackets or ribs which are part of the frame, which are positioned underneath the PV laminate and support said PV laminate in regions away from the frame edge;
a mount support to raise one side of said PV laminate, wherein said mount support is rotatably attached to said mounting frame along one edge by hinges, said mount support being rotatable to and from a nested position within said mounting frame;
at least one mount foot attached to said mount support using hinges and rotatable to and from a nested position within said mounting frame, and having a snapping connection to said mounting frame, bracket or rib or a back side of said PV laminate.

2. The photovoltaic system of claim 1, wherein said mount foot is nested within said mounting frame essentially at 180 degrees with respect to said mount support.

3. The photovoltaic system of claim 1, wherein said mount foot includes an adhesive for attachment to a roof.

4. The photovoltaic system of claim 1, wherein said mount foot contains honeycomb or rib shaped features.

5. The photovoltaic system of claim 1, further comprising a snow mount which is nested within said frame for transport and is moveable from said nesting position to an installed position such that a central mechanical support of said photovoltaic system is achieved.

6. The photovoltaic system of claim 1, further comprising a carrying handle positioned about the center of said PV module.

7. The photovoltaic system of claim 1, further comprising integrated cable management, wherein cables from a junction box mounted on the PV laminate are preassembled such as to be routed along said PV mounting frame, brackets or ribs to mount supports, and wherein cable connectors are configured to be factory installed about regions where neighboring modules are connected.

8. The photovoltaic system of claim 1, further comprising locations along the mounting frame or mount support, where homerun cables are guided and suspended off the surface using flexible clips.

9. The photovoltaic system of claim 1, further comprising a connector to connect neighboring systems in the direction not connected via mount feet, wherein said connector is configured to be rotatably positioned upon installation, to connect with a neighbor panel.

10. The photovoltaic system of claim 1, further comprising a connector system with a connecting plate or bar and connection position, wherein both panel and connection positions comprise serrated circular arches of connecting surfaces, and wherein said panel bar allows for a solid connection even for uneven roof surfaces.

11. The photovoltaic system of claim 1, wherein the mount support further comprises a wind deflector panel configured for engagement by sliding from a nesting position in the mount support to its installed position between modules.

12. The photovoltaic system of claim 1, wherein the material for the frame in contact with said PV laminate is comprised of plastic or fiber reinforced plastic, and wherein said material is electrically isolating and thus grounding of said frame is not required.

13. The photovoltaic system of claim 1, wherein said mount foot has a hook attachment bar, wherein hooks are arranged along the edge opposed from the edge holding said mount support, wherein said hooks are configured for attachment to said hook attachment bar of a neighboring photovoltaic system, and wherein said neighboring photovoltaic system is oriented in the same direction as said photovoltaic system.

14. The photovoltaic system of claim 1, wherein said mount foot has a hook attachment bar having hooks along the edge opposed from the edge holding said mount support, wherein said hooks are attachable to said hook attachment bar of a neighboring like photovoltaic system, and wherein said hook attachment bar allows for arranging said neighboring photovoltaic system in a mirror orientation to said photovoltaic system.

15. The photovoltaic system of claim 1, wherein the material for the frame in contact with said PV laminate is comprised of plastic or fiber reinforced plastic, and wherein part of frame, bracket or ribs includes a cold formed steel profile.

16. A photovoltaic system, comprising:
a first photovoltaic module laminate attached to a photovoltaic mounting frame, said mounting frame having essentially a rectangular shape;
one or more brackets or ribs which are part of the frame, which are positioned underneath the first PV laminate and support same in regions away from the frame edge;
a mount support to raise one side of said first PV laminate system, wherein said mount support is rotatably attached to said mounting frame along one edge by hinges, said mount support being rotatable to and from a nested position within said mounting frame;
at least one ridge mount foot attached to said mount support using hinges and rotatable to and from a nested position within said mounting frame, and having a snapping connection to said mounting frame, bracket or rib or a back side of said PV laminate, wherein said ridge mount foot is comprised of a snapping position to receive the PV mount support of a second PV laminate;
a second photovoltaic module laminate attached to a photovoltaic mounting frame, said mounting frame having essentially a rectangular shape;
one or more brackets or ribs which are part of the frame, which are positioned underneath the first PV laminate and support same in regions away from the frame edge;
a mount support to raise one side of said second PV laminate system, wherein said mount support is rotatably attached to said mounting frame along one edge by hinges, said mount support being rotatable to and from a nested position within said mounting frame; wherein said mount support of said second PV laminate has a barbed edge, and wherein said barbed edge can be mated to said ridge mount foot of first PV laminate system via said snapping position on the ridge mount foot attached to mount support of first PV laminate system;
said second photovoltaic module further comprising at least one valley foot, said valley foot attachable to and removable from a nested position within the frame of said second PV laminate system; wherein said valley foot can be attached to said first and second PV laminates via hooks attached to at least one edge of each said mounting frame.

17. The photovoltaic system of claim 15, wherein said valley foot has slots to enable alignment of said hooks.

18. The photovoltaic system in claim 15, wherein said edge of said second PV laminate containing hooks contains a lifter device enabling at least temporary lifting of said edge.

19. A photovoltaic system, comprising:
a first photovoltaic module attached to a photovoltaic mounting frame, said mounting frame having essentially a rectangular shape;
one or more brackets or ribs which are part of the frame, which are placed in suitable locations underneath the first PV laminate and support said PV laminate in regions away from the frame edge;
a mount support to raise one side of said first PV laminate system, wherein said mount support is rotatably attached to said mounting frame along one edge by hinges, said mount support being able to be rotated to and from a nested position within said mounting frame;
at least one ridge mount foot attached to said mount support using hinges and rotatable to and from a nested position within said mounting frame;
a second photovoltaic module attached to a photovoltaic mounting frame, said mounting frame having essentially a rectangular shape;
one or more brackets or ribs which are part of the frame, which are placed in suitable locations underneath the first PV laminate and support said first PV laminate in regions away from the frame edge;
a mount support to raise one side of said second PV laminate, wherein said mount support is rotatably attached to said mounting frame along one edge by hinges, said mount support being able to be rotated to and from a nested position within said mounting frame;
wherein said mount support of said second PV laminate and said mount support of said first PV laminate each comprise a receptacle structure allowing said PV mount of said second PV laminate to attach by sliding or snapping into said PV mount of said first PV laminate.
